(19) United States
(12) Patent Application Publication
(10) Pub. No.: US 2013/0158947 A1
(43) Pub. Date: Jun. 20, 2013

(54) INFORMATION PROCESSING APPARATUS, CONTROL METHOD FOR INFORMATION PROCESSING APPARATUS AND STORAGE MEDIUM

(71) Applicant: CANON KABUSHIKI KAISHA, Tokyo (JP)

(72) Inventor: Masahiro Suzuki, Kawasaki-shi (JP)

(73) Assignee: CANON KABUSHIKI KAISHA, Tokyo (JP)

(21) Appl. No.: 13/683,650

(22) Filed: Nov. 21, 2012

(30) Foreign Application Priority Data
Dec. 20, 2011 (JP) 2011-278751

(51) Int. Cl. G01B 11/00; G06F 15/00

(52) U.S. Cl. CPC G01B 11/00; G06F 15/00
USPC 702/155

(57) ABSTRACT

An information processing apparatus comprises a first sensor unit configured to obtain, as first information, two-dimensional information or three-dimensional information about a target object; a first measurement unit configured to measure a position and orientation of the target object by analyzing the first information; a second sensor unit mounted on a robot for executing an operation for the target object, and configured to obtain, as second information, two-dimensional information or three-dimensional information about the target object in a position and orientation determined based on a measurement result by the first measurement unit; and a second measurement unit configured to measure the position and orientation of the target object by analyzing the second information.

### BACKGROUND OF THE INVENTION

1. Field of the Invention

The present invention relates to an information processing apparatus, a control method for the information processing apparatus, and a storage medium.

2. Description of the Related Art

Along with recent development of robot techniques, it is becoming a common practice for a robot to do complex tasks such as assembly of industrial products instead of humans. Such a robot does assembly by picking up parts using its end effector such as a hand. Conventionally, parts to be picked up are supplied using an apparatus called a parts feeder for arranging and supplying parts one by one, or supplied by laying parts in a heap in various orientations in a palette (box). If a parts feeder is used, each part is supplied in a predetermined position and orientation, and thus a robot relatively easily picks it up. It, however, additionally costs to prepare the parts feeder. Furthermore, it may be necessary to prepare different parts feeders for parts with different shapes. On the other hand, if parts laid in a heap are supplied, it is only necessary to place the parts in the pallet, thereby avoiding an increase in cost. Furthermore, because of the recent trend of high-mix low-volume production, supplying parts laid in a heap, which can immediately accommodate various parts, is receiving attention.

Japanese Patent No. 03556589 discloses the following method. That is, a camera arranged above a palette captures a plurality of target objects as a whole, and a two-dimensional position in the captured image is obtained. After that, a straight line from the camera to one target object is obtained to move a robot so that a sensor mounted on the hand portion of the robot is positioned on the straight line. The sensor measures the position and orientation of the target object. In this way, a target object is measured with high accuracy at high speed by performing processing in stages with a combination of the camera which captures the whole view and the sensor which has a small measurement range but can detect the position and orientation with high accuracy.

In the method in Japanese Patent No. 03556589, however, the sensor mounted on the hand portion of the robot has to perform measurement on the straight line connecting the target object with the camera arranged above the palette. Depending on the orientation of the target object, it may be difficult to perform measurement. For example, the target object receives illumination light for measurement, which may be reflected on the camera by the target object depending on its orientation. If the reflected light of illumination is reflected on the camera beyond expectation, this interferes with image processing, thereby making it difficult to measure the position and orientation. Alternatively, if the target object is placed so that it is difficult to see, from a direction in which the target object is measured, a feature portion for specifying the position and orientation of the target object, it is difficult to obtain the position and orientation with high accuracy.

### SUMMARY OF THE INVENTION

The present invention has been made in consideration of the above problems, and provides a technique of robustly measuring a target object with high accuracy at high speed even though the target object orients in any direction.

According to one aspect of the present invention, there is provided an information processing apparatus comprising: a first sensor unit configured to obtain, as first information, two-dimensional information or three-dimensional information about a target object; a first measurement unit configured to measure a position and orientation of the target object by analyzing the first information; a second sensor unit mounted on a robot for executing an operation for the target object, and configured to obtain, as second information, two-dimensional information or three-dimensional information about the target object in a position and orientation determined based on a measurement result by the first measurement unit; and a second measurement unit configured to measure the position and orientation of the target object by analyzing the second information.

According to one aspect of the present invention, there is provided a control method for an information processing apparatus, comprising the steps of: obtaining, as first information, two-dimensional information or three-dimensional information about a target object; measuring a position and orientation of the target object by analyzing the first information; obtaining, as second information, two-dimensional information or three-dimensional information about the target object in a position and orientation determined based on a measurement result in the measuring; and measuring the position and orientation of the target object by analyzing the second information.

Further features of the present invention will be apparent from the following description of exemplary embodiments with reference to the attached drawings.

### BRIEF DESCRIPTION OF THE DRAWINGS

FIG. 1 is a view showing the arrangement of an information processing apparatus according to the first embodiment;

FIGS. 2A to 2F are views for explaining a three-dimensional geometric model according to the first embodiment;

FIG. 3 is a view for explaining processing of generating a reference image model according to the first embodiment;

FIG. 4 is a flowchart illustrating a processing procedure by the information processing apparatus according to the first embodiment;

FIGS. 5A and 5B are views for explaining processing of detecting an edge from an image;

FIG. 6 is a view for explaining the relationship between the projection image of a line segment and a detected edge;

FIGS. 7A and 7B are views each for explaining an image captured by a sensor unit;

FIGS. 8A and 8B are views each for explaining the relationship between the sensor unit and a target object;

FIG. 9 is a view for explaining an image captured by the sensor unit; and

FIGS. 10A to 10C are views for explaining a three-dimensional geometric model according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

In the first embodiment, the three-dimensional position and orientation of a target object is measured using a first sensor unit (a camera) for obtaining two-dimensional information (a two-dimensional image) about the target object, and a second sensor unit (a projector and a camera) which is mounted on a robot and is used to obtain three-dimensional information about the target object. More specifically, the measurement position and orientation of the second sensor unit mounted on the robot is set based on the result of measurement using the first sensor unit so that the reflected light of the projector illumination of the second sensor unit for measurement is not reflected on the camera of the second sensor unit. The reflected light of the projector illumination may be reflected on the camera beyond expectation depending on the relative relationship between the orientation of the camera and that of the target object, and thus the accuracy of image processing decreases. As the accuracy of image processing decreases, the accuracy of three-dimensional position and orientation measurement also drops. To deal with this problem, in the embodiment, the second sensor unit performs measurement in the position and orientation which does not cause the reflected light of the projector illumination to be reflected on the camera, in order to perform three-dimensional position and orientation measurement with high accuracy.

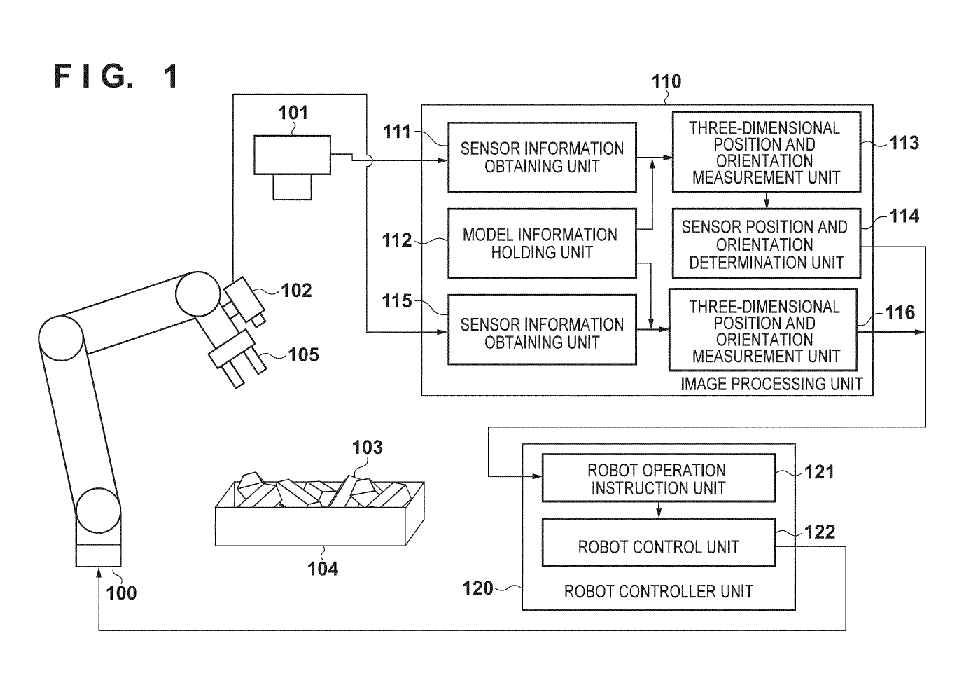

The arrangement of an information processing apparatus according to the first embodiment will be described with reference to FIG. 1. The information processing apparatus includes a robot 100, a first sensor unit 101, a second sensor unit 102, an image processing unit 110, and a robot controller unit 120. The image processing unit 110 includes a first sensor information obtaining unit 111, a model information holding unit 112, a first three-dimensional position and orientation measurement unit 113, a sensor position and orientation determination unit 114, a second sensor information obtaining unit 115, and a second three-dimensional position and orientation measurement unit 116. The robot controller unit 120 includes a robot operation instruction unit 121 and a robot control unit 122. The components measure the three-dimensional position and orientation of each of target objects 103 laid in a heap in a palette 104. Based on a measurement result, the robot 100 picks up a target object.

Each unit forming the information processing apparatus according to the embodiment will be described below. The robot 100 is an articulated robot, which operates in response to a control instruction from the robot controller unit 120. A hand 105 serving as an end effector is mounted on the distal end of the robot 100, which enables to perform an operation for the target object 103. In this embodiment, a hand with a chuck mechanism for enabling to grip the target object 103 as an end effector is used. As an end effector, a motor-driven hand or a suction pad for sucking the target object 103 by air pressure may be used.

Assume that prior to processing, calibration operations have been performed by well-known techniques for the position and orientation of the sensor unit 101, the position and orbit of the robot 100 or hand 105, and the relative position and orientation between the arm of the robot 100 and the sensor unit 102. This makes it possible to convert positions and orientations measured by the first three-dimensional position and orientation measurement unit 113 and the second three-dimensional position and orientation measurement unit 116 into those in a work space coordinate system fixed in a space in which the palette is placed. It is also possible to control the robot 100 to set the hand 105 to a position and orientation designated in the work space coordinate system.

The sensor unit 101 serves as a camera for capturing a two-dimensional image (first image). The first sensor unit 101 is fixed in the first position and orientation above the palette 104, captures an image of the target objects 103 laid in a heap, and outputs the image to the first sensor information obtaining unit 111. Although the image processing unit 110 processes the image captured by the sensor unit 101 in the embodiment, the sensor unit 101 may include an image processing mechanism to output a result of image processing.

To capture the target objects 103 by the sensor unit 101, an illuminator (not shown) irradiates the target objects 103 with illumination light (projection light). The illuminator is arranged around the sensor unit 101 to enable the sensor unit 101 to capture a two-dimensional image of the target objects 103 in a uniform illumination environment.

The sensor unit 102 includes a compact projector and a compact camera for capturing a two-dimensional image (second image). The sensor unit 102 is fixed near the hand 105 of the robot 100, and measures an object near the end effector in a second position and orientation controllable by the angle of each joint of the robot 100. Assume that the relative positional relationship between the compact projector and compact camera of the second sensor unit 102 has been obtained in advance by calibration. Although the image processing unit 110 processes the image captured by the sensor unit 102 in the embodiment, the sensor unit 102 may include an image processing mechanism to output a result of image processing.

The compact projector of the sensor unit 102 irradiates the target object 103 with pattern light (projection light), and the compact camera of the sensor unit 102 captures the target object 103 on which the pattern light is projected, thereby outputting the captured image to the second sensor information obtaining unit 115. For the pattern light, a pattern of a plurality of lines or a pattern of a plurality of stripes with different widths in a space encoding method is used. A two-dimensional pattern or random dot pattern may also be used. The sensor unit 102 may include a diffraction grating, an illuminator, and a camera. In this case, the diffraction grating and illuminator project pattern light on the target object 103, and the camera captures a pattern. The captured pattern image is used by the second three-dimensional position and orientation measurement unit 116 via the second sensor information obtaining unit 115 to obtain a distance using the principle of triangulation.

The target object 103 is a part forming an industrial product. The robot 100 picks up the target object 103, and arranges it in the product. Various materials such as plastic, metal, or vinyl can be used for the target object 103. The plurality of target objects 103 are laid in a heap in the palette 104 in various orientations.

The palette 104 is a box in which the target objects 103 are placed. Although the material of the palette is not limited, plastic or paper is often used. Furthermore, although the shape of the palette is not limited, it is often a cube or rectangular parallelepiped in terms of ease of creation. Although the size of the palette is not also limited, it is generally determined so that it falls within the measurement range of the sensor unit 101.

Each component of the image processing unit 110 will now be described.

The first sensor information obtaining unit 111 obtains the two-dimensional image captured by the sensor unit 101. The unit 111 then outputs the obtained two-dimensional image to the three-dimensional position and orientation measurement unit 113.

The model information holding unit 112 holds model information which is used to measure the position and orientation of the target object 103 by the first three-dimensional position and orientation measurement unit 113 or second three-dimensional position and orientation measurement unit 116. An example of the model information is three-dimensional geometric model information based on three-dimensional CAD.

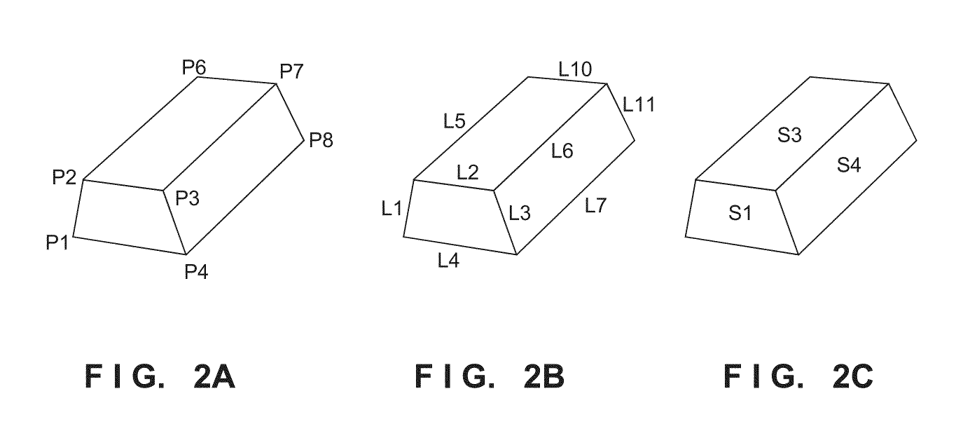

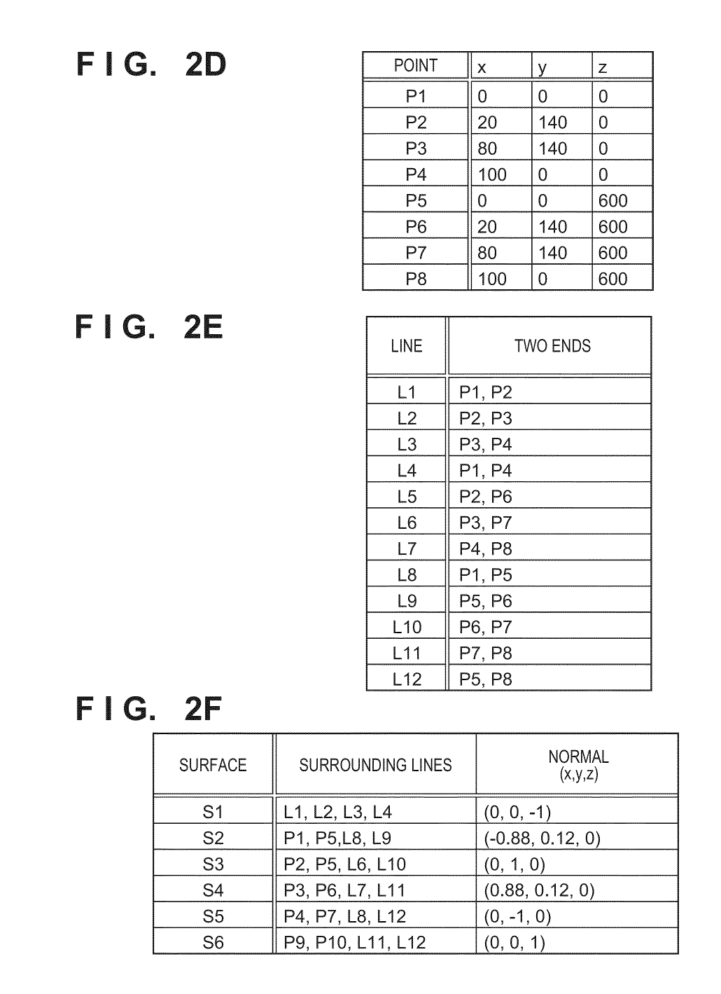

The three-dimensional geometric model indicates a CAD model itself which can be dealt with by three-dimensional CAD software, or is obtained by converting a three-dimensional CAD model into a plurality of polygon elements used in the computer graphics field. A case in which polygon elements are used will be described in this embodiment. The three-dimensional geometric model includes components such as vertices, lines, and surfaces as shown in FIGS. 2A to 2F. FIGS. 2A to 2C show the same three-dimensional geometric model. FIGS. 2A and 2D show each vertex of the three-dimensional geometric model. FIGS. 2B and 2E show lines which correspond to the respective sides of the three-dimensional geometric model. FIGS. 2C and 2F show each surface of the three-dimensional geometric model. The three-dimensional geometric model includes data of the normal to each surface forming the three-dimensional geometric model, as shown in FIG. 2F.

Another example of the model information is reference image information obtained by observing, from a plurality of predetermined viewpoints, the actual target object 103 or a three-dimensional geometric model of the target object 103.

A reference image model as reference image information is data including a plurality of two-dimensional images. A reference image model based on an actually captured image is created based on images obtained by capturing, with the camera, an image centered on the target object 103 from various directions. A plurality of cameras may be arranged by setting up a scaffold, the user may hold a camera to capture an image, or the user may capture an image with a camera mounted on a robot while moving the robot. Although a capturing operation may be performed in any method, the relative position and orientation between the camera and target object 103 in capturing an image is obtained, and is stored together with the captured image. If a plurality of cameras are arranged on a scaffold, the relative position and orientation can be obtained based on the shape of the scaffold. If the user holds a camera, it is possible to obtain the relative position and orientation by mounting a position and orientation sensor on the camera. If an image is captured by a camera mounted on a robot, the relative position and orientation can be obtained using the control information of the robot.

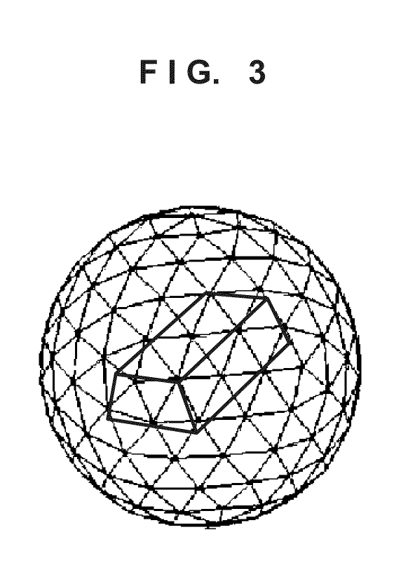

For the reference image model based on the three-dimensional geometric model of the target object 103, an image obtained by setting a geodesic sphere which has vertices at equal distances from the center of the CAD model, and observing the CAD model from the vertex of the geodesic sphere towards the center of the CAD model is used. The geodesic sphere has a plurality of vertices, which are spaced apart from each other at regular intervals. By setting a given vertex as a reference position, a direction from which the model is observed is obtained based on the relative relationship with another vertex, and is stored together with an image. FIG. 3 shows the CAD model and a geodesic sphere surrounding it. An image obtained by observing the center from each vertex of the geodesic sphere is used as a reference image model. Note that the reference image model may be a luminance image or distance image. If it is already known that there is only one type of target object 103, only the model information of that type is stored. If a plurality of types of target objects 103 are dealt with, a plurality of pieces of model information are stored, and are switched when used.

The three-dimensional position and orientation measurement unit 113 obtains the position and orientation of the target object 103 using data obtained by analyzing the two-dimensional image output from the first sensor information obtaining unit 111, and the model information held by the model information holding unit 112 (first measurement processing). The unit 113 then outputs the obtained position and orientation information to the sensor position and orientation determination unit 114.

If a three-dimensional geometric model is used as model information, the position and orientation of the target object 103 is obtained by associating a line as a side of the three-dimensional geometric model with an edge component extracted from the two-dimensional image output from the first sensor information obtaining unit 111. In the embodiment, the coarse position and orientation of the target object 103 is repeatedly corrected by an iterative operation so that the three-dimensional geometric model corresponds to the two-dimensional image.

If a reference image model is used as model information, a reference image which most likely matches the reference image model is obtained by template matching using the reference image model as a template, and the position and orientation of the target object 103 is obtained based on the position and orientation information of the target object 103 associated with the obtained reference image.

Based on the position and orientation of the target object 103 obtained by the first three-dimensional position and orientation measurement unit 113, the sensor position and orientation determination unit 114 determines the second position and orientation as the position and orientation of the second sensor unit 102 when it measures the target object 103. The unit 114 outputs the obtained position and orientation information to the robot operation instruction unit 121. A method of obtaining the position and orientation of the sensor unit 102 when it measures the target object 103 will be described later.

The second sensor information obtaining unit 115 obtains a two-dimensional image captured by the sensor unit 102. The sensor unit 102 includes a compact projector for emitting pattern light. The second sensor information obtaining unit 115 obtains an image of the target object 103 irradiated with the pattern light. The unit 115 then outputs the obtained two-dimensional image to the three-dimensional position and orientation measurement unit 116.

The three-dimensional position and orientation measurement unit 116 obtains the position and orientation of the target object 103 using data obtained by analyzing the two-dimensional image output from the second sensor information obtaining unit 115, and the model information held by the model information holding unit 112 (second measurement processing). The unit 116 then outputs the obtained position and orientation information to the robot operation instruction unit 121.

If a three-dimensional geometric model is used as model information, the position and orientation of the target object 103 is obtained by associating the point set data of a surface extracted from the three-dimensional geometric model with a distance point set extracted from a two-dimensional pattern image output from the second sensor information obtaining unit 115. To obtain a distance point set from the pattern image, a well-known technique such as a space encoding method or light-section method can be used, and a detailed description thereof will be omitted. To obtain the position and orientation of the target object 103 using the obtained distance point set and the model information, the ICP (Iterative Closest Point) method is used in the embodiment. The position and orientation of the target object 103 is repeatedly corrected by an iterative operation. Note that the method of obtaining the position and orientation of the target object 103 is not limited to the ICP method.

If a reference image model is used as model information, a reference image which most likely matches the reference image model is obtained by template matching using the reference image model as a template, and the position and orientation of the target object 103 is obtained based on the position and orientation information of the target object 103 associated with the obtained reference image.

Each component of the robot controller unit 120 will now be described.

The robot operation instruction unit 121 sends an operation instruction for the robot based on the measurement result of the sensor position and orientation determination unit 114 and three-dimensional position and orientation measurement unit 116. According to an output from the sensor position and orientation determination unit 114, the robot operation instruction unit 121 instructs to move the sensor unit 102 to the second position and orientation for measuring the target object 103. Furthermore, according to an output from the three-dimensional position and orientation measurement unit 116, the unit 121 instructs to move the hand 105 to a position, where it is possible to grip or suck the target object 103, to grip or suck the target object 103. The robot operation is not limited to movement, gripping, or suction, and also includes other operations such as inspection of the appearance of the target object 103, as a matter of course. Furthermore, the robot need not be an articulated robot, and may be a movable machine controllable by NC, as a matter of course.

Upon receiving instruction information from the robot operation instruction unit 121, the robot control unit 122 controls the robot 100.

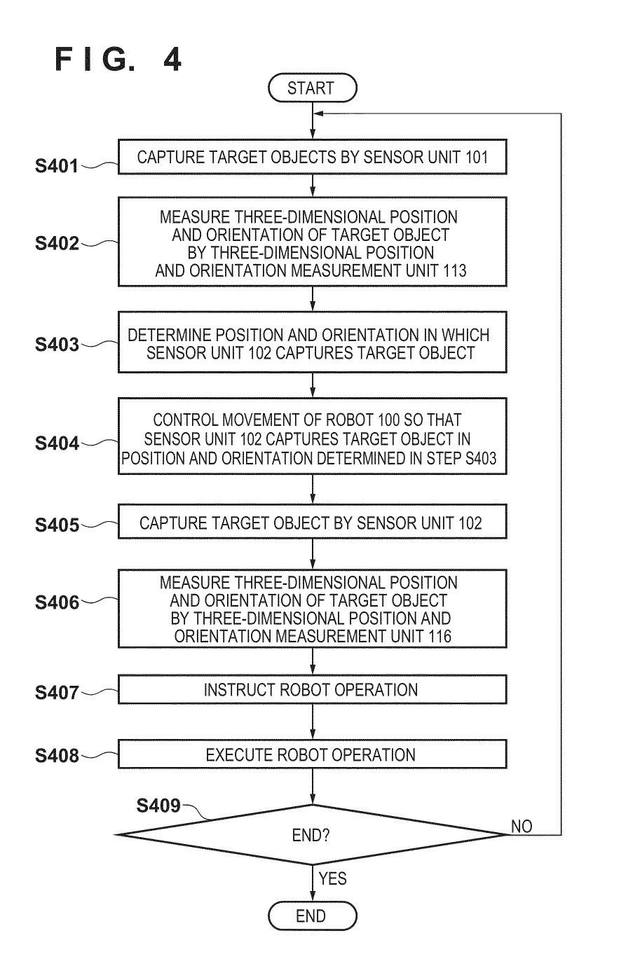

A processing procedure by the information processing apparatus according to the first embodiment will be described with reference to a flowchart shown in FIG. 4.

In step S401, the sensor unit 101 fixed above the palette 104 in the first position and orientation captures an image of the target objects 103. The captured image is output to the first sensor information obtaining unit 111. Assume that the position and orientation of the sensor unit 101 has been obtained in advance by calibration.

In step S402, the three-dimensional position and orientation measurement unit 113 measures the position and orientation of at least one of the plurality of target objects 103 from the image of the target objects 103, which has been obtained by the first sensor information obtaining unit 111. To obtain the position and orientation of the target object 103, the model information holding unit 112 outputs the model information held in itself, and the three-dimensional position and orientation measurement unit 113 matches the image of the target objects 103 with the model information.

If a three-dimensional geometric model is used as model information, the position and orientation of the target object 103 is obtained by associating a line as a side of the three-dimensional geometric model with an edge component extracted from the two-dimensional image output from the first sensor information obtaining unit 111. In the embodiment, the coarse position and orientation (represented by a six-dimensional vector s) of the target object 103 is repeatedly corrected by an iterative operation using the Gauss-Newton method as a nonlinear optimization method so that the three-dimensional geometric model corresponds to the two-dimensional image.

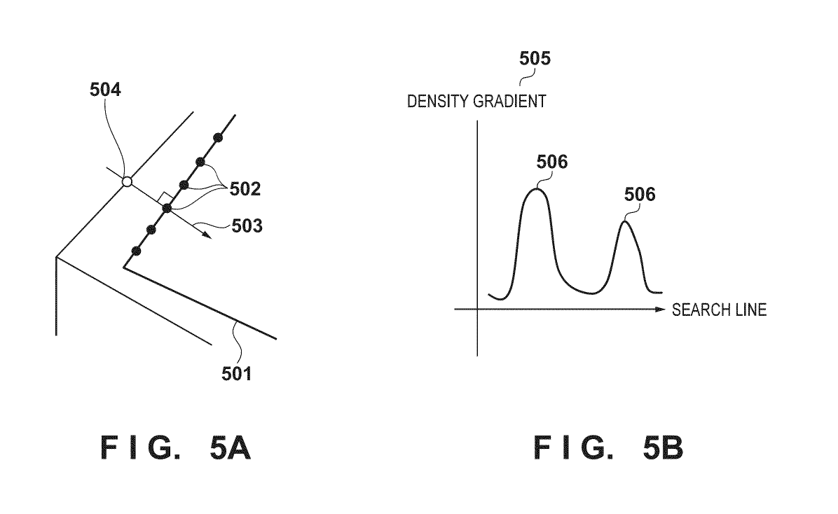

Edge detection processing will be described with reference to FIGS. 5A and 5B. A projection image, on the image, of each line segment forming the three-dimensional geometric model is calculated using the coarse position and orientation of the target object 103 which has been obtained by some method (for example, template matching), and the calibrated intrinsic parameters of the sensor unit 101. The projection image of a line segment also represents a line segment on the image. As shown in FIG. 5A, control points 502 are set on a projected line segment 501 at regular intervals on the image. For each control point 502, a one-dimensional edge 504 is detected in a direction 503 of the normal to the projected line segment 501. Since an edge is detected as a local maximum of a density gradient 505 of a pixel value, a plurality of edges 506 may be detected, as shown in FIG. 5B. In this embodiment, all the detected edges are held as temporary edges.

To obtain the position and orientation of the target object 103 by associating a line segment as a side of the three-dimensional geometric model with an edge component of the two-dimensional image output from the first sensor information obtaining unit 111, an error vector and a coefficient matrix for calculating the position and orientation are calculated. Note that each element of the coefficient matrix is a first-order partial differential coefficient associated with each element of the position and orientation when setting the distance between a point and a straight line on the image as a function of the position and orientation. For edges, the error vector indicates the signed distance between a projected line segment and a detected edge on the image. Deriving of the coefficient matrix will now be described.

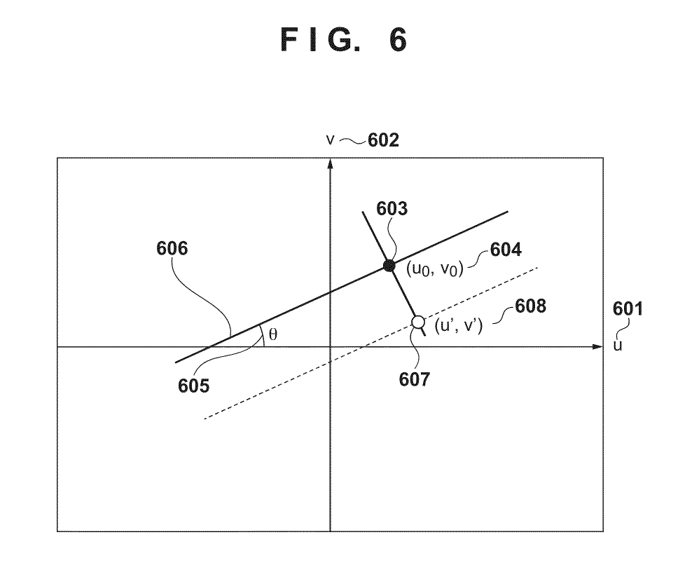

FIG. 6 is a view for explaining the relationship between the projection image of a line segment and a detected edge. Referring to FIG. 6, a u-axis 601 represents the horizontal direction of the image and a v-axis 602 represents the vertical direction of the image. (u0, v0) represents coordinates 604 of a given control point 603 (one of points for dividing each projected line segment at regular intervals on the image) on the image, and a slope θ 605 with respect to the u-axis 601 represents the slope, on the image, of the line segment to which the control point belongs. The slope θ 605 is calculated by projecting, on the image, the three-dimensional coordinates of two ends of a line segment 606 based on the six-dimensional vector s representing the position and orientation of the target object 103, and obtaining the slope of a straight line connecting the coordinates of the two ends on the image. (sin θ, −cos θ) represents the normal vector of the line segment 606 on the image. Let (u′, v′) be coordinates 608 of a point 607 corresponding to the control point 603 on the image. Then, a point (u, v) on the straight line (a broken line in FIG. 6) which passes through the coordinates 608 (u′, v′) of the corresponding point 607, and has the slope θ 605 can be represented by:

u sin θ−v cos θ=d (1)

where θ is a constant, and d=u′ sin θ−v′ cos θ.

The position of the control point 603 on the image changes depending on the position and orientation of the target object 103. The position and orientation of the target object 103 has six degrees of freedom. That is, s indicates a six-dimensional vector, and includes three elements representing the position of the target object 103, and three elements representing the orientation of the target object 103. The three elements representing the orientation are represented by, for example, Euler angles, or a three-dimensional vector, the direction of which represents a rotation axis passing through the origin, and the norm of which represents a rotation angle. The coordinates (u, v) of a point on the image, which change depending on the position and orientation can be approximated by the first-order Taylor expansion near the coordinates 604 (u0, v0) as given by:

$$\begin{matrix}u \approx {u}_{0} + {\sum }_{i = 1}^{6} \frac{\partial u}{\partial {s}_{i}} Δ {s}_{i} \\ v \approx {v}_{0} + {\sum }_{i = 1}^{6} \frac{\partial v}{\partial {s}_{i}} Δ {s}_{i}\end{matrix} \} \qquad ( 2 )$$

where Δsi (i=1, 2, . . . , 6) represents the infinitesimal change of each element of the six-dimensional vector s.

Assume that the difference between the coarse position and orientation and the actual position and orientation is not so large. In this case, it can be assumed that the position of a control point on the image, which is obtained by a correct six-dimensional vector s, is on the straight line represented by equation (1). Substituting u and v approximated according to expressions (2) into equation (1) yields:

$$sin θ {\sum }_{i = 1}^{6} \frac{\partial u}{\partial {s}_{i}} Δ {s}_{i} - cos θ {\sum }_{i = 1}^{6} \frac{\partial v}{\partial {s}_{i}} Δ {s}_{i} = d - r \qquad ( 3 )$$

where r=u0 sin θ−v0 cos θ (a constant).

Equation (3) applies for all edges each associated with a side. Note that equation (3) may be applied to only some edges instead of all edges.

Since equation (3) is associated with the infinitesimal change Δsi (i=1, 2, . . . , 6) of each element of the six-dimensional vector s, linear simultaneous equations for Δsi are obtained as represented by:

$$[ \begin{matrix}sin {θ}_{1} \frac{\partial u}{\partial {s}_{1}} - cos {θ}_{1} \frac{\partial v}{\partial {s}_{1}} & sin {θ}_{1} \frac{\partial u}{\partial {s}_{2}} - cos {θ}_{1} \frac{\partial v}{\partial {s}_{2}} & … & sin {θ}_{1} \frac{\partial u}{\partial {s}_{6}} - cos {θ}_{1} \frac{\partial v}{\partial {s}_{6}} \\ sin {θ}_{2} \frac{\partial u}{\partial {s}_{1}} - cos {θ}_{2} \frac{\partial v}{\partial {s}_{1}} & sin {θ}_{2} \frac{\partial u}{\partial {s}_{2}} - cos {θ}_{2} \frac{\partial v}{\partial {s}_{2}} & … & sin {θ}_{2} \frac{\partial u}{\partial {s}_{6}} - cos {θ}_{2} \frac{\partial v}{\partial {s}_{6}} \\ ⋮ & ⋮ & ⋱ & ⋮\end{matrix} ] [ \begin{matrix}Δ {s}_{1} \\ Δ {s}_{2} \\ Δ {s}_{3} \\ Δ {s}_{4} \\ Δ {s}_{5} \\ Δ {s}_{6}\end{matrix} ] = [ \begin{matrix}{d}_{1} - {r}_{1} \\ {d}_{2} - {r}_{2} \\ ⋮\end{matrix} ] \qquad ( 4 )$$

Equation (4) is represented by:

JΔs=E (5)

To calculate a coefficient matrix J of the linear simultaneous equations, a partial differential coefficient is calculated. According to equation (5), the correction value Δs of the position and orientation is obtained using the generalized inverse matrix (JT·J)−1·JT of the coefficient matrix J based on the least squares criterion. Since, however, many outliers may be obtained for edges due to error detection or the like, a robust estimation method as will be described below is used. For an edge as an outlier, the value of the error vector on the right side of equation (4) is generally large. Therefore, a small weight is given to information for which the absolute value of an error is large, and a large weight is given to information for which an error is small. The weights are given by a Tukey function as represented by:

$$\begin{matrix}w ( z ( d - r ) ) = \{ \begin{matrix}{( 1 - {( z ( d - r ) / {c}_{1} )}^{2} )}^{2} & \vert z ( d - r ) \vert \leq {c}_{1} \\ 0 & \vert z ( d - r ) \vert > {c}_{1}\end{matrix} \\ w ( e - q ) = \{ \begin{matrix}{( 1 - {( ( e - q ) / {c}_{2} )}^{2} )}^{2} & \vert e - q \vert \leq {c}_{2} \\ 0 & \vert e - q \vert > {c}_{2}\end{matrix}\end{matrix} \} \qquad ( 6 )$$

Note that c1 and c2 are constants. A function of giving weights need not be a Tukey function, and any function such as a Huber function may be used as long as the function gives a small weight to information for which an error is large, and gives a large weight to information for which an error is small. Let wi be a weight corresponding to each piece of measurement information (an edge or point set data). A weight matrix W is defined by:

$$W = [ \begin{matrix}{w}_{1} & & & 0 \\ & {w}_{2} & & \\ & & ⋱ & \\ 0 & & & \end{matrix} ] \qquad ( 7 )$$

The weight matrix W is a square matrix in which all elements except for diagonal elements are 0, and the diagonal elements have weights wi. Using the weight matrix W, equation (5) is rewritten to:

WJΔs=WE (8)

The correction value Δs is obtained by solving equation (8) as represented by:

Δs=(J^{T}WJ)⁻¹J^{T}WE (9)

The coarse position and orientation is corrected with the calculated correction value Δs of the position and orientation (s←s+Δs).

Whether the six-dimensional vector s has converged is determined. If the six-dimensional vector has converged, the calculation operation ends; otherwise, the calculation operation is repeated. When the correction value Δs is almost equal to 0, or the sum of squares of an error vector before correction is almost equal to that after correction, it is determined that the six-dimensional vector s has converged. As described above, it is possible to calculate the position and orientation by repeating the calculation operation until the six-dimensional vector s converges.

Note that the method using the Gauss-Newton method as an optimization method has been described in the embodiment. A Levenberg-Marquardt method which is robust in calculation or a steepest descent method as a simpler method may be used. Furthermore, another nonlinear optimization calculation method such as a conjugate gradient method or ICCG method may be used.

On the other hand, if a reference image model is used as model information, a reference image which most likely matches the reference image model is obtained by template matching using the reference image model as a template, and the position and orientation of the target object 103 is obtained based on the position and orientation information of the target object 103 associated with the obtained reference image. Let T(i, j) be the luminance of the reference image, and I(i, j) be the luminance of the two-dimensional image. Then, assuming that the reference image is an image with m×n pixels, it is possible to obtain the degree of matching according to:

$$R = {\sum }_{j = 0}^{n - 1} {\sum }_{i = 0}^{m - 1} {( I ( i , j ) - T ( i , j ) )}^{2} \qquad ( 10 )$$

When the three-dimensional position and orientation measurement unit 113 obtains the position and orientation of the target object 103, it outputs the position and orientation information of the target object 103 to the sensor position and orientation determination unit 114.

In step S403, based on the three-dimensional position and orientation of the target object 103 obtained in step S402, the sensor position and orientation determination unit 114 determines the second position and orientation in which the sensor unit 102 measures the target object 103. In the embodiment, the unit 114 determines the position and orientation of the sensor unit 102 mounted on the robot 100 so that the reflected light of the projector illumination for measuring the target object 103 is not directly reflected on the camera. The sensor position and orientation determination unit 114 then outputs the determined position and orientation to the robot operation instruction unit 121.

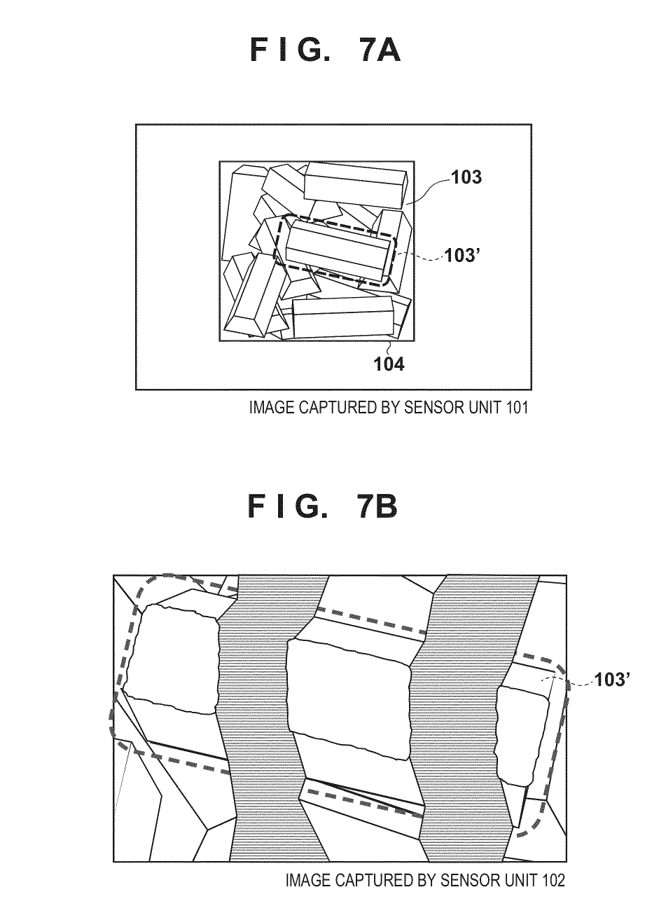

FIGS. 7A and 7B each show an image obtained by capturing the target objects 103 by the sensor unit. FIG. 7A shows an image captured by the sensor unit 101. FIG. 7B shows an image captured by the sensor unit 102. Referring to FIG. 7A, the image includes many target objects 103 laid in a heap in the palette 104. In step S402, the three-dimensional position and orientation of at least one of the target objects 103 is obtained. Assume that the three-dimensional position and orientation of one target object 103′ has been obtained for descriptive convenience. The three-dimensional positions and orientations of the plurality of target objects 103 have been obtained and one of them may be selected as the target object 103′, as a matter of course. In FIGS. 7A and 7B, the target object 103′ is surrounded by dotted lines. These dotted lines are drawn for making it easy to identify the target object 103′, and thus are not included in each image captured by the sensor unit.

FIG. 7B shows the image captured by the sensor unit 102 for measuring the fine three-dimensional position and orientation of the target object 103′. Assume that the image shown in FIG. 7B has been obtained by placing the sensor unit 102 on a straight line connecting the sensor unit 101 with the target object 103′, and capturing an image. That is, the method described in Japanese Patent No. 03556589 as a conventional technique determines a capturing position. The measurement range of the sensor unit 102 is smaller than that of the sensor unit 101. The area of the target object 103′ in the image captured by the sensor unit 102, which occupies a screen, is larger than that in the image captured by sensor unit 101. The space encoding method is applied in the embodiment for measuring the fine three-dimensional position and orientation. The compact projector of the sensor unit 102 projects pattern light with a plurality of stripes with different widths, and the small camera captures an image. FIG. 7B reveals that the pattern light with stripes are projected on the target object 103′. The stripes of the stripe pattern change to conform to the shape of the target object, and the changed pattern is captured. A plurality of images are captured while changing the widths of the stripes of the stripe pattern.

The target object 103′ receives the illumination light of the projector of the sensor unit 102 from a close position. If a given surface of the target object 103′ is almost perpendicular to a direction obtained by halving an angle formed by the optical-axis direction of the camera of the sensor unit 102 and that of the projector as shown in FIG. 7B, the illumination light is specularly reflected by the surface of the target object 103′, and the reflected light of illumination is directly reflected on the camera. More specifically, if the direction obtained by halving the angle formed by the optical-axis direction of the camera and that of the projector is almost parallel to the direction of the normal to the surface of the target object 103′, the projector illumination light is specularly reflected, and the reflected light is directly reflected on the camera. The luminance of an image portion of the surface of the target object 103′ is in a saturation state, and a blown-out highlight occurs in the image. To perform three-dimensional measurement using the space encoding method, it is necessary to obtain, with high accuracy, the boundary positions of regions corresponding to the black and white portions of the stripe pattern. If, however, a blown-out highlight occurs in the image region in which the target object 103′ exists, an image is captured while the white region expands, and thus shifted boundary positions are detected. Since it is impossible to obtain the boundary positions with high accuracy, it is difficult to obtain the position and orientation with high accuracy.

In Japanese Patent No. 03556589 as a conventional technique, a line sensor is used as a sensor mounted on the hand portion of the robot. Even if the line sensor is used, when the line pattern light is specularly reflected by the surface of the target object, and the reflected light is directly reflected on the sensor, the image portion of a line where the specular reflection has occurred expands. It is, therefore, difficult to obtain the position of the line with high accuracy. Since it is impossible to obtain the position of the line with high accuracy, it becomes difficult to obtain the position and orientation with high accuracy.

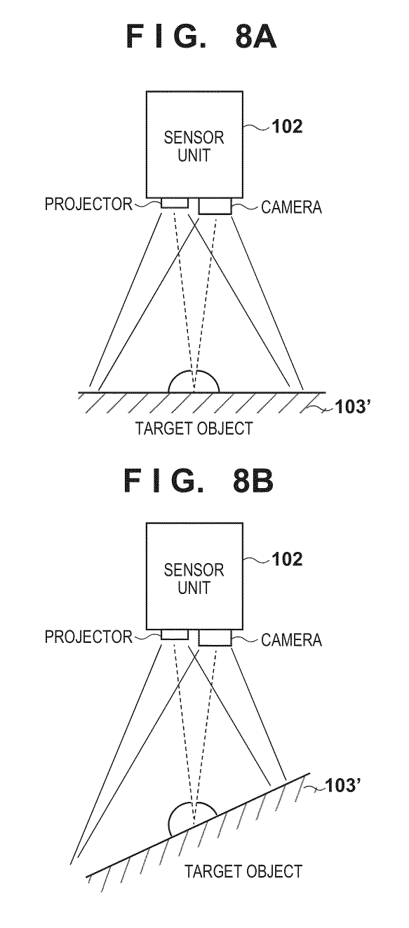

In step S403, based on the relationship between the normal to a surface forming the target object 103′ and the direction obtained by halving the angle formed by the optical-axis direction of the camera of the sensor unit 102 and that of the projector, the sensor position and orientation determination unit 114 determines the second position and orientation in which the sensor unit 102 captures an image. FIGS. 8A and 8B are views for explaining the relationship between a surface forming the target object 103′ and the projector and camera of the sensor unit 102. FIG. 8A shows a state in which the direction obtained by halving the angle formed by the optical-axis direction of the camera and that of the projector is almost parallel to the direction of the normal to the surface of the target object 103′. The optical axis of the projector and that of the camera have the relationship such that the specular reflection occurs on the surface of the target object 103′. In this state, the pattern light of the projector is specularly reflected by the surface of the target object 103′ on the camera. As a result, a blown-out highlight occurs, thereby making it difficult to detect the three-dimensional position and orientation of the target object 103′ by image processing. Note that in order to cause the irradiation range of the projector to overlap the capturing range of the camera as much as possible, the optical axis of the projector and that of the camera have slightly tilted with respect to the orientation of the sensor unit 102. The directions of the optical axis of the camera and that of the projector may be different from those shown in FIG. 8, as a matter of course. The optical axis of the camera may orient in the vertically downward direction, and the optical axis of the projector may further tilt in the counterclockwise direction.

On the other hand, referring to FIG. 8B, the surface of the target object 103′ tilts by a given angle with respect to the direction obtained by halving the angle formed by the optical-axis direction of the camera of the sensor unit 102 and that of the projector. The light of the projector is never specularly reflected on the camera. More specifically, since the direction of the normal to the surface of the target object 103′ shifts from the direction obtained by halving the angle formed by the optical-axis direction of the camera and that of the projector, the light of the projector is never specularly reflected on camera. As a result, the occurrence of a blown-out highlight in the image is suppressed, thereby making it easy to detect the three-dimensional position and orientation of the target object 103′ by image processing.

Since the sensor unit 102 is mounted on the robot, it is possible to obtain the position and orientation of the sensor unit 102 based on the control information of the robot. Furthermore, the position and orientation of the target object 103′ has been obtained in step S402, and if the three-dimensional geometric model is used as a model, the normal to the surface of the target object has also been identified as described with reference to FIG. 2. In order not to cause the light of the projector of the sensor unit 102 to be specularly reflected on the camera, the robot control information, the position and orientation of the target object 103′ obtained in step S402, and the information of the normal to the surface of the target object 103′ are used. The orientation at this time is set as the orientation of the second position and orientation when the sensor unit 102 performs measurement. More specifically, method A, B, or C to be described below implements the above processing.

<Method A>

By temporarily setting, to the vertically downward direction, the direction obtained by halving the angle formed by the optical-axis direction of the camera of the sensor unit 102 and that of the projector, a region where the target object 103′ exists is captured. If no blown-out highlight has occurred in the portion of the target object 103′ in the image, it is possible to determine that the light of the projector is not specularly reflected on the camera. Whether a blown-out highlight has occurred can be determined by checking the luminance of the image. If no blown-out highlight has occurred, the position and orientation of the sensor unit 102 which is capturing the target object 103′ at this time is set as the second position and orientation. If a blown-out highlight has occurred in the portion of the target object 103′ in the image, the orientation of the sensor unit 102 is rotated about the position of the target object 103′ by a predetermined angle (for example, 5°) within a plane including the optical axes of the camera and projector. When no blown-out highlight occurs, the position and orientation of the sensor unit 102 which is capturing the target object 103′ at this time is set as the second position and orientation. If a blown-out highlight still occurs although the orientation of the sensor unit 102 is rotated, the orientation of the sensor unit 102 is further rotated by the predetermined angle until no blown-out highlight occurs. Note that the orientation of the sensor unit 102 may be rotated within a plane perpendicular to the plane including the optical axes of the camera and projector, or may be rotated in an arbitrary direction. In method A, since it is determined whether a blown-out highlight has occurred in the actually captured image, it is possible to reliably determine the second position and orientation in which no blown-out highlight occurs.

<Method B>

The position and orientation of the sensor unit 102 is simulated. By setting, to the vertically downward direction, the direction obtained by halving the angle formed by the optical-axis direction of the camera of the sensor unit 102 and that of the projector, the sensor unit 102 is virtually arranged at a position for capturing a region in which the target object 103′ exists. The sensor unit 102 is rotated about the position of the target object 103′ by a predetermined angle (for example, 5°) within a plane including the optical axes of the camera and projector. A position where the direction obtained by halving the angle formed by the optical-axis direction of the camera and that of the projector shifts from the direction of the normal to the surface of the target object 103′ by a predetermined angle (for example, 10°) or larger is obtained, and the position and orientation is set as the second position and orientation. If there are a plurality of second position and orientation candidates, the position and orientation when the sensor unit 102 almost orients in the vertically downward direction is set as the second position and orientation. The orientation of the sensor unit 102 may be rotated within a plane perpendicular to the plane including the optical axes of the camera and projector, or may be rotated in an arbitrary direction. In method B, since simulation is performed, it is possible to determine the second position and orientation without requiring a time to repeat a measurement operation while actually moving the robot.

<Method C>

The position and orientation of the sensor unit 102, which is suitable for measurement, may be registered in advance in the three-dimensional geometric model or reference image model. A plurality of positions and orientations may be registered, or the range of the position and orientation may be registered. The registered position and orientation closest to the current position and orientation of the sensor unit 102 is set as the second position and orientation.

Note that in any of methods A to C, the distance between the sensor unit 102 and the target object 103′ is determined based on the range of the focal length of the camera of the sensor unit 102. The range of the focal length of the camera is determined based on the shortest capturing distance of the camera and the depth of field. Therefore, the position of the sensor unit 102 exists within a given distance range centered at the target object 103′.

Since the three-dimensional geometric model has a plurality of surfaces, the capturing position of the sensor unit 102 is preferably determined so that no blown-out highlight occurs in all the surfaces. Depending on the shape of the three-dimensional geometric model, it may be difficult to determine the position so that no blown-out highlight occurs in all the surfaces. In this case, the position may be determined so that an angle difference is equal to or larger than a predetermined threshold on surfaces as many as possible. Furthermore, since a surface with a small area has a small influence on a final result, such surface can be ignored. Since the computation amount reduces, the speed at which the second position and orientation when the sensor unit 102 performs measurement is determined improves. Alternatively, a portion of the target object 103′, which is gripped or sucked by the robot hand, may be designated in advance, and surfaces except for those around the portion may be ignored. The robot can perform a picking operation with high accuracy by especially obtaining the position and orientation around the portion gripped or sucked by the robot hand with high accuracy.

The second position and orientation when the sensor unit 102 captures the target object 103′ is not limited to one position in the three-dimensional space. Since the second position and orientation is determined within a spatial range, one position need only be selected within the range to capture the target object 103′. Alternatively, the position and orientation determined by simultaneously applying a method (to be described later) may be selected as the second position and orientation.

If a reference image model is used as a model, each reference image model is associated with the angle information of a surface of the target object 103′, and the position and orientation in which the sensor unit 102 captures an image is determined based on the position and orientation of the sensor unit 102 and the angle information associated with the reference image mode. Association of the angle information is performed by a program for advance preparation in an advance preparation step of reading CAD data into the model information holding unit 112.

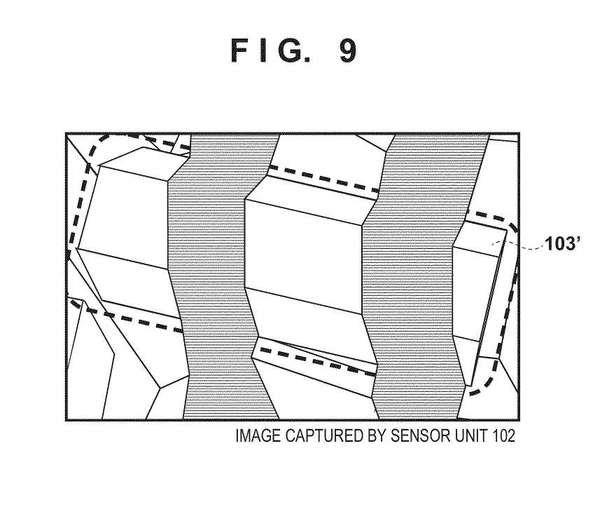

FIG. 9 shows an image obtained by capturing almost the same region as that shown in FIG. 7B in the position and orientation obtained by rotating the sensor unit 102 to the right side by several degrees. The capturing position and orientation has been determined by obtaining a position where the direction obtained by halving the angle formed by the optical-axis direction of the camera and that of the projector shifts from the direction of the normal to the surface of the target object 103′ by a predetermined angle or larger, as described in this embodiment. Since the target object 103′ is captured without any blown-out highlight, it is possible to obtain the boundary positions of the regions corresponding to the black portion and white portion of the stripe pattern with high accuracy. Since it is possible to obtain the boundary positions with high accuracy, it becomes easy to obtain the position and orientation of the target object 103′ with high accuracy.

Note that since the second position and orientation changes depending on the shape of the target object, it also changes depending on the type of target object.

In step S404, the robot control unit 122 controls the orientation of the robot 100 so that the sensor unit 102 captures the target object 103′ in the second position and orientation determined in step S403. In step S404, the robot operation instruction unit 121 first receives the position and orientation information determined in step S403 from the sensor position and orientation determination unit 114. Based on the information output from the sensor position and orientation determination unit 114, the robot operation instruction unit 121 instructs to move the robot 100 so that the sensor unit 102 captures the target object 103′. The robot control unit 122 controls the robot 100 based on the instruction given by the robot operation instruction unit 121.

In step S405, the sensor unit 102 mounted on the robot 100 captures an image of the target object 103′. The captured image is output to the second sensor information obtaining unit 115.

In step S406, the three-dimensional position and orientation measurement unit 116 obtains the position and orientation of the target object 103′ based on the image of the target object 103′, which has been obtained by the second sensor information obtaining unit 115. To obtain the position and orientation of the target object 103′, the model information holding unit 112 outputs the model information held in itself, and the three-dimensional position and orientation measurement unit 116 matches the target object 103′ with the model information.

If a three-dimensional geometric model is used as model information, the position and orientation of the target object is obtained by associating the point set of a surface extracted from the three-dimensional geometric model with a distance image point set extracted from a pattern image output from the second sensor information obtaining unit 115. To obtain a distance point set from the pattern image, it is only necessary to use a well-known technique such as the space encoding method or light-section method, and a detailed description thereof will be omitted in the embodiment. To associate the point set of the three-dimensional geometric model with the distance image point set, the ICP (Iterative Closest Point) method is used in the embodiment.

Let P be the point set of the surface of the three-dimensional geometric model, and A be the distance image point set. Then, P and A are respectively represented by:

P={p₁, p₂, . . . , p_{N}_{ₚ}} (11)

A={a₁, a₂, . . . , a_{N}_{ₐ}} (12)

The point set P of the surface of the three-dimensional geometric model is converted to be aligned with the distance point set A. Assume that a point of the point set A, which is closest to each point pi of the point set P in terms of the distance, is represented by biεA. In this case, an error function is defined by:

$$E ( R , t ) = {\sum }_{i = 1}^{{N}_{p}} {‖ {b}_{i} - ( {Rp}_{i} + t ) ‖}^{2} \qquad ( 13 )$$

where R represents an orientation parameter, and t represents a motion vector.

R and t which make the error function E small are obtained to perform correction according to:

P←RP+t (14)

As a method of obtaining R and t which make the error function E small, a method described in K. S. Arun, T. S. Huang, and S. D. Blostein, “Least-Squares Fitting of Two 3-D Point Sets”, PAMI, Vol. 9, No. 5, 1987 is used.

Whether P has converged is determined. If P has converged, the correction calculation ends; otherwise, the correction calculation is repeatedly performed. When P hardly changes, it is determined that P has converged. It is possible to calculate the position and orientation by repeating the calculation until P converges.

If a reference image model is used as model information, a reference image which most likely matches the reference image model is obtained by template matching using the reference image model as a template, and the position and orientation of the target object is obtained based on the position and orientation information of the target object associated with the obtained reference image. Let T(i, j) be the distance value of the reference image, and I (i, j) be the distance value of the distance image obtained based on the pattern image. Then, assuming that the reference image is an image with m×n pixels, it is possible to obtain the degree of matching according to:

$$R = {\sum }_{j = 0}^{n - 1} {\sum }_{i = 0}^{m - 1} {( I ( i , j ) - T ( i , j ) )}^{2} \qquad ( 15 )$$

When the three-dimensional position and orientation measurement unit 116 obtains the position and orientation of the target object 103′, it outputs the position and orientation information of the target object 103′ to the robot operation instruction unit 121. Note that since an image is captured in the second position and orientation determined in step S403, the pattern image is an image without any blown-out highlight, as shown in FIG. 9. It is, therefore, possible to obtain the position and orientation of the target object 103′ with high accuracy.

In step S407, based on the position and orientation information of the target object 103′ received from the three-dimensional position and orientation measurement unit 116, the robot operation instruction unit 121 sends an operation instruction for the robot 100 to the robot control unit 122. If the robot 100 includes a hand for gripping the target object 103′, the unit 121 instructs to grip the target object 103′. Alternatively, if the robot 100 includes a pad for sucking the target object 103′, the unit 121 instructs to suck the target object 103′. In step S408, the robot control unit 122 controls the robot 100 to execute contents of the instruction which has been given by the robot operation instruction unit 121 in step S407. To cause the robot 100 to grip the target object 103′, the robot control unit 122 controls the robot 100 to grip the target object 103′. Alternatively, to cause the robot 100 to suck the target object 103′, the robot control unit 122 controls the robot 100 to suck the target object 103′.

In step S409, the robot control unit 122 determines whether an end instruction has been received from the user. If it is determined that an end instruction has been received from the user (YES in step S409), the process ends; otherwise (NO in step S409), the process returns to step S401. Note that the user may press an emergency stop button (not shown) to end the procedure and to stop all the operations without standing by for the end determination operation in step S409.

As described above, in the first embodiment, the three-dimensional position and orientation of the target object is measured using the first sensor unit (camera) for obtaining two-dimensional information (a two-dimensional image) about the target object, and the second sensor (projector and camera) which is mounted on the robot and is used to obtain three-dimensional information about the target object. Based on the result of measurement using the first sensor unit, the measuring position and orientation of the second sensor unit mounted on the robot is obtained so that the reflected light of the projector illumination of the second sensor unit for measurement is not reflected on the camera of the second sensor unit. This allows robust measurement with high accuracy at high speed even though the target object orients in any direction.

[Modification]

In a modification of the first embodiment, the sensor unit 101 may be a sensor unit (distance image sensor or three-dimensional point set measurement sensor) for obtaining three-dimensional information (a distance image or three-dimensional point set data) about a target object. Furthermore, the sensor unit 102 may be a sensor unit (distance image sensor or three-dimensional point set measurement sensor) for obtaining three-dimensional information (a distance image or three-dimensional point set data) about a target object. As a sensor unit for obtaining a distance image, a distance image sensor including a projector and a camera which are similar to those used in the second sensor unit, or a TOF distance image sensor for measuring the depth to each pixel by a light propagation time. The three-dimensional information need not be distance image data arranged in a two-dimensional array, and may be three-dimensional point set data measured as a sparse point set. The first sensor information obtaining unit 111 and the second sensor information obtaining unit 115 obtain three-dimensional information (distance images or three-dimensional point set data) from the sensor unit 101 and sensor unit 102, and output the obtained information to the three-dimensional position and orientation measurement units 113 and 116, respectively. The three-dimensional position and orientation measurement unit 113 obtains the position and orientation of the target object by associating the three-dimensional information (the distance image or three-dimensional point set data) output from the first sensor information obtaining unit 111 with the point set data of a surface extracted from the three-dimensional geometric model output from the model information holding unit 112. The three-dimensional position and orientation measurement unit 116 obtains the position and orientation of the target object by associating the three-dimensional information (the distance image or three-dimensional point set data) output from the second sensor information obtaining unit 115 with the point set data of the surface extracted from the three-dimensional geometric model output from the model information holding unit 112. To obtain the position and orientation of the target object using the three-dimensional information (distance image or three-dimensional point set data) and the model information, the ICP (Iterative Closest Point) method is used. The position and orientation of the target object is repeatedly corrected by an iterative operation. Note that the optimization method for obtaining the position and orientation of the target object is not limited the ICP method.

In another modification of the first embodiment, the sensor unit 101 may be a sensor unit (a combination of a camera and a distance sensor) for obtaining, as first information, two-dimensional information (a two-dimensional image) or three-dimensional information (a distance image or three-dimensional point set data) about the target object, or both the pieces of information. Furthermore, the sensor unit 102 may be a sensor unit (a combination of a camera and a distance sensor) for obtaining, as second information, two-dimensional information (a two-dimensional image) or three-dimensional information (a distance image or three-dimensional point set data) about the target object, or both the pieces of information. As a method of simultaneously solving association of the two-dimensional image with the model information, and association of the distance data with the model information, a method described in Japanese Patent Laid-Open No. 2011-27623 is applicable.

In still another modification of the first embodiment, the projector of the sensor unit 102 can irradiate the whole surface with uniform luminance light instead of the pattern light. By irradiating the surface with uniform luminance light, it is possible to consider the projector as a general illuminator. In this case, the compact projector of the sensor unit 102 irradiates a target object with uniform luminance light, and the compact camera of the sensor unit 102 obtains two-dimensional information (a two-dimensional image), thereby outputting the obtained information to the second sensor information obtaining unit 115. The sensor unit 102 may include an illuminator for illuminating the target object with uniform brightness light and a camera for capturing a two-dimensional image. The second sensor information obtaining unit 115 obtains the two-dimensional image, and outputs it to the three-dimensional position and orientation measurement unit 116. The three-dimensional position and orientation measurement unit 116 measures the position and orientation of the target object using the two-dimensional image and the model information output from the model information holding unit 112. The method of measuring the position and orientation may be the same as that used by the three-dimensional position and orientation measurement unit 113 in step S402 in the first embodiment.

### Second Embodiment

In the first embodiment, the measurement position and orientation of the second sensor unit mounted on the robot is set based on the result of measurement using the first sensor unit so that the reflected light of the projector illumination of the second sensor unit for measurement is not reflected on the camera of the second sensor unit. In the second embodiment, the position and orientation of a second sensor unit mounted on a robot is set based on the result of measurement using a first sensor unit so that it is possible to measure a feature portion of a target object.

Each processing unit forming an information processing apparatus according to the second embodiment is basically the same as that shown in FIG. 1 in the first embodiment. Note that target objects 103, model information held in a model information holding unit 112, and processing contents by a sensor position and orientation determination unit 114 are different from those in the first embodiment.

A flowchart illustrating a processing procedure by the information processing apparatus according to the second embodiment is basically the same as that shown in FIG. 4 in the first embodiment. Note that the target objects 103, and processing contents in step S403 of determining a position and orientation in which a sensor unit 102 captures a target object are different from those in the first embodiment.

In this embodiment, only components different from the first embodiment will be described. Other components are the same as those in the first embodiment.

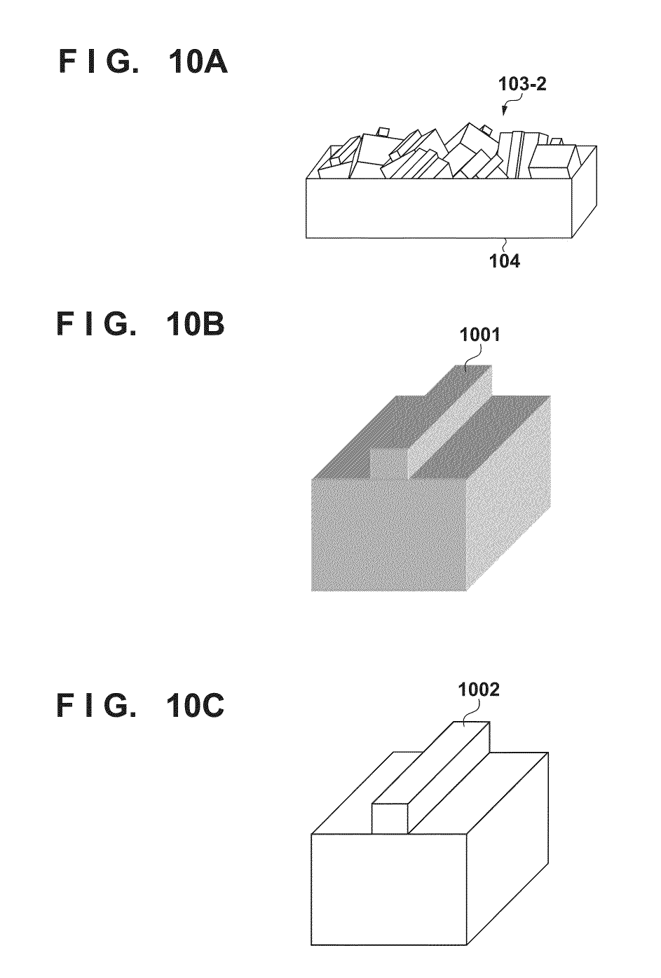

In the second embodiment, target objects 103-2 shown in FIG. 10A are measured instead of the target objects 103 shown in FIG. 1. FIG. 10A shows a state in which the target objects 103-2 are laid in a heap in a palette 104. FIG. 10B shows the shape of the target object 103-2. The target object 103-2 has, as a feature 1001, a characteristic bulged part on a rectangular parallelepiped. The feature 1001 is used as a guide when arranging the target object 103-2 in a product. Note that a term “characteristic” is used to mean that it is possible to obtain information which contributes to determination of the three-dimensional position and orientation of the target object 103-2 with high accuracy.

FIG. 10C shows a three-dimensional geometric model based on the CAD data of the target object 103-2. Similarly to the three-dimensional geometric model shown in FIG. 2, the model has information about points, lines, and surfaces. The target object 103-2 has a model feature 1002 corresponding to the feature 1001.

In the second embodiment, based on the position and orientation of a given target object 103-2′ measured by the three-dimensional position and orientation measurement unit 113, the sensor position and orientation determination unit 114 determines the position and orientation when the sensor unit 102 performs measurement. Since the three-dimensional position and orientation measurement unit 113 has obtained the position and orientation of the target object 103-2′ in advance, the three-dimensional geometric model has been aligned with the target object 103-2′ with accuracy to some extent. The sensor position and orientation determination unit 114 determines, as a second position and orientation, a position and orientation in which the sensor unit 102 can measure the feature 1001 corresponding to the model feature 1002. The sensor unit 102 measures the position and orientation in the second position and orientation in which it is possible to measure the feature 1001, thereby enabling to align the characteristic portion of the model. It is, therefore, possible to obtain the position and orientation of the target object with high accuracy.

To obtain the second position and orientation in which it is possible to measure the feature 1001, one of methods (1) to (3) is used.

(1) Position and Orientation in which it is Possible to Observe at Least One Surface of Model Feature 1002

To enable the sensor unit 102 to three-dimensionally measure the feature 1001 of the target object 103-2′, a position and orientation in which it is possible to observe at least one surface of the model feature 1002 need only be determined as the second position and orientation. Note that if it is required to obtain the position and orientation of the target object with higher accuracy, a position where it is possible to observe three or more surfaces is desirable.

To obtain such the second position and orientation, the optical direction of the camera of the sensor unit 102 is temporarily set to the vertically downward direction to capture a region where the target object 103-2′ exists. If it is possible to observe at least one surface of the model feature 1002, the position and orientation of the sensor unit 102 which is capturing the target object 103-2′ at this time is set as the second position and orientation. If no surface of the model feature 1002 is observed, the orientation of the sensor unit 102 is rotated about the position of the target object 103-2′ within a plane including the optical axes of the camera and projector by a predetermined angle (for example, 5°). If it is possible to observe at least one surface of the model feature 1002, the position and orientation of the sensor unit 102 which is capturing the target object 103-2′ at this time is set as the second position and orientation. Note that the orientation of the sensor unit 102 may be rotated within a plane perpendicular to the plane including the optical axes of the camera and projector, or may be rotated in an arbitrary direction. If it is impossible to observe any surface of the model feature 1002 even though the sensor unit 102 is rotated a predetermined number of times, measurement of the target object 103-2′ is temporarily stopped, and another target object may be set as a target or the palette may be shaken to change the state of the heap of the target objects. With method (1), since it is determined based on the three-dimensional geometric model whether it is possible to observe a surface of the target object 103-2′, the second position and orientation in which it is possible to measure the feature 1001 can be reliably determined.

Note that since it is assumed that the three-dimensional geometric model has been aligned with the target object 103-2′ with accuracy to some extent, the second position and orientation is determined based on the model feature (as described above).

(2) Position and Orientation in which Optical-Axis Direction of Camera of Sensor Unit 102 Forms Angle Smaller than 90° with Predetermined Surface of Model Feature 1002

To enable the sensor unit 102 to three-dimensionally measure the feature 1001 of the target object 103-2′, the direction of the normal to the upper surface of the model feature 1002 in FIG. 10C need only form a relative angle smaller than 90° with the optical-axis direction of the camera of the sensor unit 102. Setting the relative angle to be smaller than 90° enables to measure at least one surface of the feature 1001, thereby allowing to three-dimensionally measure the feature 1001. Similarly to method (1), in method (2), it is only necessary to perform measurement by temporarily setting the optical-axis direction of the camera of the sensor unit 102 to the vertically downward direction, and to rotate, if the condition is not satisfied, the sensor unit 102 by a predetermined angle.

Note that in the first embodiment, the second position and orientation is obtained so that the relative angle is equal to or larger than a predetermined angle. The second position and orientation may be determined by obtaining the common range between the range in the first embodiment and that in the second embodiment.

(3) The position and orientation of the sensor unit 102, which is suitable for measurement, may be registered in advance in the three-dimensional geometric model or reference image model. A plurality of positions and orientations may be registered, or the range of the position and orientation may be registered. The registered position and orientation closest to the current position and orientation of the sensor unit 102 is set as the second position and orientation.

Note that in addition to the three-dimensional feature as shown in FIG. 10C, the model feature of the three-dimensional geometric model may be a two-dimensional geometric feature (a combination of a line and an arc, texture, and the like), a one-dimensional geometric feature (a line or arc), or a point feature.

If the reference image model is used, it is only necessary to set, as the second position and orientation, the position and orientation when based on the position and orientation of the target object 103-2′ measured by the three-dimensional position and orientation measurement unit 113, the reference image of a relative position and orientation in which it is possible to observe a feature portion more clearly is selected to create the reference image.

### Third Embodiment

As a modification of the first and second embodiments, the following embodiment is considered. One sensor unit forms a sensor unit 101 and sensor unit 102. More specifically, the sensor unit 102 mounted on a robot also has a function of the sensor unit 101. The robot is controlled to capture target objects 103 in a first position and orientation in which the sensor unit 102 is positioned above a palette 104. When the sensor unit 102 captures the target objects 103 in the first position and orientation, and a first three-dimensional position and orientation measurement unit 113 measure a position and orientation, a second position and orientation in which it is possible to measure the target object 103 with high accuracy is determined. The method described in the first or second embodiment is used to determine the second position and orientation. The sensor unit 102 is moved to the second position and orientation by controlling the robot. The sensor unit 102 then captures the target object 103, and a second three-dimensional position and orientation measurement unit 116 measures a position and orientation. The end effector of the robot 100 grips or sucks the target object 103.

If the target object 103 includes a mirror reflection component, a position where reflection is difficult to occur may be determined as the second position and orientation based on a direction obtained by halving an angle formed by the optical-axis direction of the camera of the sensor unit 102 and that of the projector, and the direction of the normal to a surface of the target object 103.

If the target object 103 includes a curved surface, a viewpoint position and orientation in which a curved surface portion (fillet portion) looks like an edge when projecting a three-dimensional geometric model of the target object 103 on an image plane may be prevented from being set as the second position and orientation as much as possible. This is because in the curved portion, the position of the edge becomes unstable depending on the viewpoint position and orientation, and the accuracy of position and orientation measurement decreases. Whether the sensor unit has the viewpoint position and orientation in which the curved portion looks like an edge is determined depending on whether there is a surface of the target object, the normal to which forms an angle of about 90° with the optical axis of the camera. Avoiding the viewpoint position and orientation in which the curved portion looks like an edge can improve the accuracy of position and orientation measurement.

When an operation of measuring the position and orientation in the second position and orientation fails (for example, it is impossible to obtain a measurement result), or a robot operation fails after measurement in the second position and orientation (for example, it is impossible to grip or suck the target object), the failure may repeatedly occur in the similar situation. By storing, for a measurement result or operation result when a failure occurs, a position and orientation with respect to the target object, the position and orientation may be excluded in subsequent processing. It is possible to improve the robustness by preventing a situation when a failure occurs from reoccurring.

As an operation by the robot, a gripping or suction operation has been exemplified. If a gripping operation is performed, the position and orientation of a position (n spaces if a hand has n fingers) for gripping the target object may be especially obtained with high accuracy. If a suction operation is performed, the position and orientation of a position (a stable surface) for sucking the target object may be especially obtained with high accuracy. The method described in the second embodiment is used by utilizing characteristic positions existing around a position to be gripped or sucked.

Although the operation of measuring the position and orientation using the model held in the model information holding unit 112 has been described, each of the sensor units 101 and 102 may include a stereo camera to measure the position and orientation of the target object by stereo measurement.

Although the robot is used to change the position and orientation of the sensor unit 102 in the above description, the present invention is not limited to this. For example, the sensor unit 102 may be mounted on a device unit obtained by combining a linear stage and a rotation stage, and the stages may be controlled to change the position and orientation. In addition to the robot for operating the target object, a position and orientation change unit may be arranged.

According to the present invention, it is possible to robustly measure a target object with high accuracy at high speed even though the target object orients in any direction.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-278751 filed on Dec. 20, 2011, which is hereby incorporated by reference herein in its entirety.

What is claimed is:

1. An information processing apparatus comprising:
a first sensor unit configured to obtain, as first information, two-dimensional information or three-dimensional information about a target object;
a first measurement unit configured to measure a position and orientation of the target object by analyzing the first information;
a second sensor unit mounted on a robot for executing an operation for the target object, and configured to obtain, as second information, two-dimensional information or three-dimensional information about the target object in a position and orientation determined based on a measurement result by said first measurement unit; and
a second measurement unit configured to measure the position and orientation of the target object by analyzing the second information.

2. The apparatus according to claim 1, further comprising
a determination unit configured to determine, as a position and orientation of said second sensor unit, a position and orientation in which reflected light of projection light projected on the target object when said second sensor unit captures the target object does not enter a capturing range of said second sensor unit, based on the measurement result by said first measurement unit.

3. The apparatus according to claim 1, further comprising
a determination unit configured to determine, as a position and orientation of said second sensor unit, a position and orientation in which it is possible to measure a feature portion of the target object, based on the measurement result by said first measurement result.

4. The apparatus according to claim 1, further comprising:
a model information holding unit configured to hold model information of the target object,
wherein said first measurement unit measures the position and orientation of the target object by matching the first information with the model information.

5. The apparatus according to claim 1, further comprising
a model information holding unit configured to hold model information of the target object,
wherein said second measurement unit measures the position and orientation of the target object by matching the second information with the model information.

6. The apparatus according to claim 4, wherein
the model information indicates three-dimensional geometric model information based on CAD data.

7. The apparatus according to claim 4, wherein
the model information includes a plurality of pieces of reference image information obtained by observing the target object or three-dimensional geometric model based on CAD data from a plurality of predetermined viewpoints.

8. The apparatus according to claim 1, wherein
if there are a plurality of types of target objects, the position and orientation of said second sensor unit is determined based on the type of the target object.

9. The apparatus according to claim 1, further comprising
a robot control unit configured to control an operation of the robot for the target object based on the position and orientation of the target object measured by said second measurement unit.

10. The apparatus according to claim 9, further comprising
a storage unit configured to store a measurement result by said second measurement unit or a result of the operation executed by the robot according to the measurement result,
wherein the position and orientation of said second sensor unit is determined by excluding a position and orientation in which measurement by said second measurement unit fails and thus a measurement result is not obtained, or a position and orientation in which the operation by the robot fails.

11. A control method for an information processing apparatus, comprising the steps of:
obtaining, as first information, two-dimensional information or three-dimensional information about a target object;
measuring a position and orientation of the target object by analyzing the first information;
obtaining, as second information, two-dimensional information or three-dimensional information about the target object in a position and orientation determined based on a measurement result in the measuring; and
measuring the position and orientation of the target object by analyzing the second information.

12. A non-transitory computer-readable storage medium storing a computer program for causing a computer to execute each step of a control method for an information processing apparatus according to claim 11.
